(19) United States
(12) Patent Application Publication
(10) Pub. No.: US 2023/0115390 A1
(43) Pub. Date: Apr. 13, 2023

(54) RECOVERY OF HIGH-VALUE COMPONENTS FROM BIOMASS

(71) Applicant: LUONNONVARAKESKUS, Helsinki (FI)

(72) Inventors: Veikko KITUNEN, Helsinki (FI); Hannu ILVESNIEMI, Helsinki (FI); Jyri MAUNUKSELA, Kauniainen (FI)

(21) Appl. No.: 17/910,773

(22) PCT Filed: Mar. 11, 2021
(86) PCT No.: PCT/FI2021/050179

§ 371 Date: Sep. 9, 2022

(30) Foreign Application Priority Data
Mar. 11, 2020 (FI) 20205257

(51) Int. Cl. C08B 37/00; B01D 11/02; B01D 5/00; C08B 37/14

(52) U.S. Cl. CPC C08B 37/0003; B01D 11/02; B01D 11/0219; B01D 5/006; B01D 11/0288; B01D 11/0207; C08B 37/14; B01D 2011/007

(57) ABSTRACT

A method for separating and recovering compounds from biomass is provided. In the method, an aqueous extraction fluid in essentially gaseous phase, such as steam, is propagated through a reaction area containing biomass feedstock. When extraction fluid advances through the biomass feedstock, in predetermined reaction conditions, a target compound separates from the essentially solid feedstock matter and travels, with the extraction fluid, towards the end of the reaction area, in where the target compound is recovered in the form of an essentially liquid medium. The method is beneficial for extracting long-chain hemicelluloses from cellulose-containing feedstocks.

### CROSS-REFERENCE TO RELATED APPLICATION(S)

This application is the U.S. national phase of International Application No. PCT/FI2021/050179 filed Mar. 11, 2021, which designated the U.S. and claims priority to FI 20205257 filed Mar. 11, 2020, the entire contents of each of which are hereby incorporated by reference.

### FIELD OF THE INVENTION

The present invention generally relates to processing and refining biomass feedstocks. In particular, the invention concerns a process for separation and recovery of valuable compounds and compound groups from biomass feedstocks with high yield and concentration using an aqueous eluent provided in essentially gaseous state.

### BACKGROUND

Sustainable exploitation of natural resources has risen, in recent decades, into a list of highly sought-after goals to achieve. Plant-derived, lignocellulosic biomass is a carbonous resource of renewable origin that provides a viable alternative for fossil carbon and related compounds and for a variety of petroleum-derived products, in particular, plastics. Forest- and agricultural industries become increasingly oriented towards exploiting the ways for smart recycling of the byproducts by redirecting their side streams for production of value-added items. Plant cells contain a great variety of compounds with clear commercial value compounds that indeed render lignocellulosic biomass a valuable resource for a wide array of applications ranging from biomaterials, production of foodstuffs to energy conversion and production of biofuels.

Conventional methods for biomass extraction aiming at isolating various components, such as cellulosic fibers, hemicelluloses and/or various (volatile) aromatic species, include, among others, solvent extraction, steam distillation, steam explosion, and pressurized hot water extraction.

Steam distillation is a process used for the recovery of volatile (organic) compounds with high boiling point from inert solids or liquids using superheated steam. Steam is carried through the material, upon which the target compounds are volatilized by absorbing heat from the steam, transported to the steam and entrained towards the condenser. The resulting vapour phase is cooled and condensed, after which the water phase is separated from the organic phase. The technique is commonly used in the extraction of essential oils from plants, for example, but it has not been used for production of fibrous component and/or polysaccharides.

Steam explosion is one of the most popular techniques for physicochemical pretreatment of lignocellulosic biomass to open up the biomass fibers and to improve the recovery of sugars and other useful compounds from biomass. Biomass feedstock is treated with medium- or high-pressure (0,6-5 MPa) saturated steam at high temperatures (160-260° C.) for a short time (several seconds to a few minutes) and then the pressure is rapidly released. Main drawbacks of the procedure are full or partial degradation of hemicellulose species and formation of toxic and/or inhibitory compounds that can cause further degradation of plant cell wall polymers.

Treating cellulosic material with steam in a batch reactor or a continuous (screw) reactor utilizing steam explosion technique is disclosed in US 2019/177292 (Marckmann et al). Patent publication discloses a method and equipment for production of target compounds, such as phenolic compounds, furans, furfurals and organic acids, from cellulosic material. Steam explosion treated steam is further directed to a steam separation device to separate the target-compound containing gas phase from solids. The steam that contains target phenolic compounds and/or organic acids is then condensed, whilst the steam-treated cellulose-containing solid matter can be transferred to another reactor for saccharification or other use related to production of bioethanol, for example.

A process for fractionating sugarcane bagasse into a high-grade cellulose pulp with high alpha-cellulose content by treating biomass with steam in a steam explosion batch reactor is further disclosed in US 2010/276093 (Varma). In the process, steam is used as a hydrolyzing chemical.

Another common method for biomass pretreatment is pressurized hot water extraction (PHWE), thereupon the solvent is pumped into an extraction chamber placed into a heated jacket at a desired temperature. The chamber containing biomass is heated, filled with extraction solvent (water) and then pressurized. In some modifications of the PHWE method that involve continuous-flow elution, preheated water may be directed into a pressurized extraction chamber. In the PHWE process, the temperature of water is above its boiling point (100° C.) but below the critical temperature (374° C.). The pressure in the extraction system is sufficiently high to keep water in a liquid form. After the reaction is complete, the chamber is rinsed with fresh extraction solvent while keeping the pressure in the chamber at an appropriate level for the desired flow. The extracts are rapidly cooled to prevent degradation. One of the major challenges faced upon conducting the method is that the extracts obtained thereby are unnecessarily diluted. Further drawbacks associated with using elevated temperatures in PHWE are decreased selectivity of the extraction, pertinent degradation of the extracted compounds, and presence of the other chemical reactions in the biomass matrix. Thus, the higher is the extraction temperature (e.g. about 200° C.), the more unwanted compounds will be extracted, leading to lower selectivity and increasing the need for purification post-treatments.

Another major problem associated with biomass extraction methods employing high temperatures (e.g. 170-250° C.) is overcooking and/or burning of biomass material, which is accompanied with irreversible damage/degradation of extractable compounds.

Moreover, in the field of refining biomass feedstocks, steam-based methods are typically used as parts of longer processes. The extracted streams containing target compounds typically require post-processing, by any of the washing, filtration or other purification method(s).

US 2010/263814 and US 2013/017589 (both by Dottori et al) disclose batch- and continuous processes, respectively, for treating lignocellulosic biomass intended for use in connection with biomass-to-ethanol processes to improve the overall yield of ethanol. The processes involve extraction of cellulose and hemicelluloses.

Hemicelluloses isolated from wood are valuable components in pulp-, fiber- and paper industries and associated products. In addition, coniferous trees contain valuable materials for chemical and food industries, and for example xylose (a monomer sugar comprised into hemicellulose polymers), raw material for xylitol, can be isolated in large quantities from deciduous trees. Hemicellulose extracts can be isolated through pressurized hot water extraction, in which the hemicelluloses are extracted in the form of aqueous streams. Hot water extraction method is disclosed in e.g. WO2009/122018 (Ilvesniemi et al), WO2014/009604 (von Schoulz) and US2019/112395 (Vähäsalo et al).

Thus, WO2009/122018 teaches a method for extracting hemicelluloses and derivatives thereof from fibrous biomass at a temperature in excess of 160° C., in particular 170-240° C., at a pressure of 0,2-10 MPa (2-100 bar), in particular 0,6-2 MPa (6-20 bar). Extraction employs water kept in aqueous phase during the whole period of extraction.

In similar manner, WO2014/009604 teaches a method for extracting sugars, derivatives thereof, and the corresponding polysaccharides from lignocellulosic biomass with hot water. Impregnation step is performed in a closed reactor under reduced pressure, e.g. 0,8 bar under pressure. However, in order to attain high concentration of hemicelluloses, the extract must be circulated through the biomass several times (e.g. ten times).

US2019/112395 discloses a method of extracting hemicelluloses from finely grinded biomass (with particle size less than 10 mm) using an aqueous medium, such as water, aqueous solution, steam, superheated steam and mixtures thereof. Biomass is thus contacted with water in a reactor vessel at a temperature between 70-250° C., preferably at 170° C. or less, at a pressure of 0,15-1 MPa (1,5-10 bar abs). Hemicellulose extract produced by the method contains dispersed colloidal substances, which makes the solution turbid and causes clogging of the downstream filters. The method requires a post-treatment step, whereupon the extract is clarified.

Furthermore, US 2019/136279 (Riva & Giordano) discloses a process for producing a bio-product from lignocellulosic biomass, wherein biomass is steam-treated in a continuous reactor and hemicelluloses are recovered. The process allows for recovering both C5 and C6 sugars from lignocellulosic biomass during the same treatment in the same reactor. Biomass can be pre-treated by soaking, thereafter biomass is introduced into a steam treatment reactor equipped with a plug screw feeder. After the reaction, pressure is rapidly released via steam explosion while discharging thus pretreated biomass from the reactor. In the process, xylans (C5 sugars) are recovered from the biomass exiting the reactor after the steam explosion. In process conditions, the intact (long-chain) hemicelluloses break down as a result of hydrolysis occurring during the pretreatment.

Apart from the above described, no alternative method has been offered suitable for fast isolation of highly pure, concentrated compounds from plant-derived biomass such that the extraction method would not necessarily require post-processing and/or post-refining steps.

In light of the data obtained previously, it appears desirable to complement and update the field of technology related to refining and processing biomass, and to develop reliable and reproducible methods for extraction of valuable compounds therefrom in an economically feasible scale which is attainable through exploitation of suitable high-temperature extraction methods, in particular, the steam extraction technology.

### SUMMARY OF THE INVENTION

An objective of the present invention is to solve or at least alleviate each of the problems arising from the limitations and disadvantages of the related art. The objective is achieved by various embodiments of a method for separation and recovery of compounds from biomass, related system and uses. Thereby, in one aspect of the invention a method for separation and recovery of compounds from biomass is provided.

In embodiment, the method comprises providing a biomass feedstock in an apparatus for processing biomass, thus forming a reaction area containing said biomass feedstock; propagating an extraction fluid in gaseous phase through the reaction area containing said biomass feedstock, in predetermined reaction conditions, whereby a target compound separates from essentially solid feedstock matter; and recovering thus separated target compound exiting the reaction area; wherein, with an advancement through the biomass material along the length of said reaction area, the extraction fluid carries the separated target compound towards the end of the reaction area such, that an extract collected upon recovery is essentially liquid, and wherein the target compounds are extracted fraction-wise such, that the target compounds forming different fractions are eluted with different retention times.

In embodiment, the method further comprises, prior to directing the extraction fluid into the reaction area, heating and optionally pressurizing said extraction fluid in a first heat-transfer unit, whereupon the extraction fluid is vaporized to form a gaseous phase. In the method, prior to formation of the gaseous phase, the extraction fluid is an aqueous solution, optionally water.

In embodiment, the biomass feedstock is cellulose-containing biomass, in particular, lignocellulosic biomass, and/or animal-derived biomass.

In embodiments, the extraction fluid is directed into the reaction area continuously or in pulses.

In embodiment, the reaction conditions include adjusting temperature within the reaction area to a range of 100-220 degrees Celsius, preferably, to a range of 150-210 degrees Celsius. In embodiment, the reaction conditions include adjusting pressure within the reaction area to a range of about 0.3 MPa to about 3 MPa, preferably, to a range of about 1 MPa to about 2 MPa.

In embodiment, the flow of the extraction fluid through the reaction area is adjusted such that a residence time the separated target compound spends in the reaction area is within a range of about 2 min to about 30 min, preferably, within a range of about 5 min to about 15 min.

In embodiment, the recovery of the target compound exiting the reaction area includes cooling the extraction fluid carrying the target compound in a second heat-transfer unit arranged downstream the reaction area to produce an essentially liquid extract rich in said target compound.

In embodiment, an amount of the extraction fluid for recovery of the target compound constitutes about 0,1-10 volumes, preferably, about 0,5-2 volumes of the biomass feedstock provided in said reaction area, the volume of the extraction fluid calculated per liquid state thereof.

In embodiment, a dry matter content in the essentially liquid extract collected upon recovery and containing the target compound is within a range of about 5 weight-% to about 30 weight-%.

In embodiment, prior to extraction with the extraction fluid, the biomass feedstock is pretreated with a pretreatment fluid to recover at least the volatile compounds, wherein pretreatment is conducted at a temperature within a range of 70-120 degrees Celsius and pressure within a range of about 0.05 mPa to about 0.5 MPa. In embodiment, the pretreatment fluid is a gaseous substance, such as vapour or gas.

In embodiment, the reaction area is formed in the apparatus for processing biomass configured as a batch reactor, a continuous-flow reactor or as a combination thereof.

In embodiment, the target compound is selected from a group consisting of cellulose, hemicellulose, lignin, sugars, proteins and low molecular weight extractive compounds, such as terpenoids, phenolic compounds, fatty acids, resin acids, and the like.

In embodiment, the target compound is an essentially intact, long-chain hemicellulose.

In another aspect, a system for separation and recovery of compounds from biomass is provided.

In embodiment, the system comprises an apparatus for processing biomass with a reaction chamber containing said biomass feedstock and forming a reaction area; means for directing an extraction fluid in a gaseous phase into the reaction chamber, whereby said extraction fluid propagates through the reaction area and separates a target compound from the essentially solid feedstock matter, and, with an advancement through the biomass material, said aqueous extraction fluid carries thus separated target compound towards the end of the reaction area; a first heat-transfer unit, in which the extraction fluid is heated and optionally pressurized to form a gaseous phase prior to entering the reaction chamber; a second heat-transfer unit, in which the extraction fluid exiting the reaction area is condensed to produce an essentially liquid extract rich in the target compound; and at least one control device to regulate reaction conditions in the reaction chamber, wherein said system is configured for fraction-wise extraction of the target compounds such, that the target compounds forming different fractions are eluted with different retention times.

In a further aspect, a method for separation and recovery of essentially intact hemicellulose compounds from lignocellulosic biomass is provided.

In embodiment, the method comprises providing a lignocellulosic biomass feedstock in an apparatus for processing biomass, thus forming a reaction area containing said biomass feedstock; propagating steam as an extraction fluid through the reaction area containing said biomass feedstock, in predetermined reaction conditions, whereby hemicellulose compounds separate from the essentially solid feedstock matter; and recovering thus separated intact hemicellulose compounds exiting the reaction area, wherein, with an advancement through the biomass material along the length of said reaction area, the aqueous extraction fluid carries thus separated hemicellulose compounds towards the end of the reaction area such, that an extract collected upon recovery is essentially liquid; wherein the recovered hemicellulose compounds are intact hemicelluloses, and wherein said hemicellulose compounds are extracted fraction-wise such, that the intact hemicellulose compounds and the products of degradation thereof forming different fractions are eluted with different retention times.

In embodiment, the method comprises adjusting temperature in the reaction area to a range between about 160-220 degrees Celsius and adjusting pressure in the reaction area to a range between about 0,6-2.5 MPa, to obtain a fraction containing 80-95% of the total amount of said intact hemicellulose compounds.

The utility of the present invention arises from a variety of reasons depending on each particular embodiment thereof. One of the major advantages offered by the method presented hereby is producing essentially intact, uncleaved polysaccharide polymers, such as hemicelluloses.

Extract obtainable by the method described hereby has high solid matter content (5-30 wt-%). The pure extract can be used as such as a food additive, such as a sweetener or a thickener to provide a functional, low-energy substitute to starch or gelatin, for example, a fodder additive or as a dispersing agent.

High quality long-chain polysaccharides, such as hemicelluloses can be further benefited, in the form of solutions or dispersions, in paint- and cosmetics industries. The method is highly suitable to produce ready-to-use extracts that does not require further concentration and/or purification. Still, the pure extract can undergo e.g. biotechnological post-refinement, such as polymerization, to produce alternatives for petroleum-derived plastics, or it can be hydrolyzed to sugars, which can be further fermented to biofuels. The pure extracts can be used a starting product for the needs of food- and/or chemical industries.

After extracting certain target compounds, e.g. hemicelluloses, from biomass material, the residue/pulp remaining in the extraction chamber can be further processed at higher temperatures and/or in presence of selected chemicals to defibrillate the cellulose bundles. This process may be assisted by mechanical refining via conventional grinding or steam explosion techniques, for example. After removal of hemicellulose species, the pulp is highly grindable and compressible. Thus, after removal hemicelluloses from biomass feedstock, the residual pulp can be further used in manufacturing of cellulose and/or of dissolving pulp.

The method disclosed hereby allows for isolating from biomass those hemicellulose species that remain in black liquor in conventional pulping techniques. The invention is thus particularly beneficial for exploitation within the paper, energy, foodstuffs and (animal) feed industries. Furthermore, the invention could be used in the processing of side streams generated in production of edible oils and cereals.

The invention further aims at increasing energy efficiency and cost effectiveness of isolating valuable compounds from lignocellulosic biomass. Compared to traditional liquid extraction the method presented hereby uses less water and it can be completed in much shorter time periods. Additionally, the method allows for producing the target compounds with high yield and selectivity. Clean steam can be further extracted from the system and reused further improving energy efficiency of the process.

Due to short processing times, formation toxic compounds, unavoidable in steam explosion, for example, is eliminated or at least minimized. Thus, an amount of lignin ending up in the hemicellulose fraction is minimized, enabling the separation of pure hemicellulose.

The method described herein is flexibly applicable to the reactors of different type and design. The method can be performed in batch- and continuous-flow systems, with or without mixing appliances (e.g. screws). Due to its versatility and low water consumption, the investment cost associated with related equipment can be kept moderate. The method is fully scalable and can be reliably conducted in industrial-scale extraction apparatuses (5-1000 m³, for example).

The terms “upstream” and “downstream” are used hereby to indicate the order of elements with regard to one another; thereby the term “upstream” is indicative of a position prior to some particular element or facility, and the term “downstream”—of a position after some particular element or facility.

The expression “a number of” refers hereby to any positive integer starting from one (1), e.g. to one, two, or three. The expression “a plurality of” refers hereby to any positive integer starting from two (2), e.g. to two, three, or four.

Different embodiments of the present invention will become apparent by consideration of the detailed description.

### BRIEF DESCRIPTION OF THE DRAWINGS

FIG. 1 is a graph illustrative of an exemplary installation for separation and recovery of target compounds from biomass feedstock, according to the method of the present invention.

FIGS. 2A and 2B are graphs illustrative of a total amount of hemicellulose carbohydrates contained in an extraction product obtained by the method of the present invention and in a residual biomass, respectively.

### DETAILED DESCRIPTION OF THE EMBODIMENTS

The invention, according to one aspect, pertains to a method for separating and recovering compounds from biomass.

The term “biomass” denotes hereby any kind of organic biodegradable raw material. The method described herein is particularly beneficial for processing cellulose-based and/or cellulose-derived biomass, including lignocellulosic biomass. Lignocellulosic biomass derived from wood- and non-wood feedstocks comprises cellulose, hemicelluloses and lignin as main components and, additionally, a set of individual compounds collectively referred to as extractives. The latter are mostly composed of the components classified as secondary metabolites, such as terpenes and terpenoids, alkaloids and phenolic compounds. In plant-derived biomass, cellulose is embedded in a matrix of lignin and hemicelluloses. Together they form tightly packed cellular structures (fibers) that form fiber bundles and are the base for the biomass tissue.

Suitable feedstocks include lignocellulosic, i.e. plant-based and/or plant-derived biomass obtainable from annual- and perennial plants (cereals, such as wheat, barley, oats, rye, maize, rice, etc., and plants as hemp, flax, and the like), forest-, bog- and field vegetation, related by-products (bagasse, cereal bran, rice husks, straw) and products derivable therefrom. Additionally or alternatively, feedstocks can include by-products of forestry (e.g. bark, wood chips, sawdust, and pulp), agriculture (biomass derived from farming, animal- and poultry rearing) and/or bio-waste.

The biomass feedstock may have initial moisture content within a range of 10-75 percent by volume (vol-%). By initial moisture content it is referred to moisture (hereby, water) content in harvested biomass loaded into the extraction tank. Fresh or pre-dried (e.g. air-dried) biomass can be utilized.

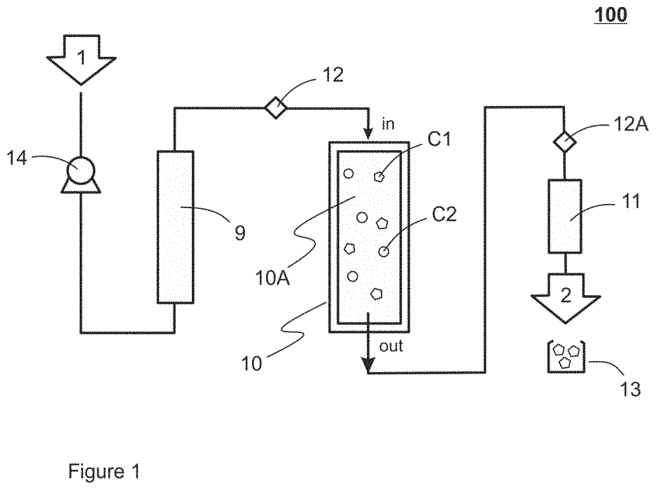

In the method, biomass feedstock is provided in an apparatus 10 for processing biomass (FIG. 1). Various reactor configurations can be adapted (described further below). By providing biomass feedstock in the apparatus 10, a reaction area 10A is formed, in where separation of target compounds from essentially solid matter occurs. The reaction area 10A is typically established in a reaction chamber of the apparatus 10.

Extraction products, referred to hereby as target compounds, include, but are not limited to: polymeric carbohydrates, such as polysaccharide polymers cellulose and hemicellulose(s), lignin, simple carbohydrates (sugars), such as glucose, mannose and galactose, for example, proteins, fats, waxes, as well as low molecular weight extractive compounds, such as terpenes and terpenoids, phenolic compounds, fatty acids, resin acids, and the like.

The method has proved particularly efficient in separation and recovery of essentially intact, uncleaved and/or unaltered compounds. Long-chain (unaltered) target compounds, such as carbohydrate polymers, for example, can be reliably produced. The research underlying the present invention had guided the inventors to a surprising outcome that essentially intact, long-chain molecules, such as hemicelluloses, can be extracted from lignocellulosic material with exceptionally high yield and purity. The target compounds obtainable upon extraction are sufficiently pure to be used, essentially without further refinement, in a variety of useful applications, such in food industry (production of foodstuffs or animal feeds). The obtained compounds, when subjected to further modifications, via chemical- and/or biotechnological processes, for example, can be exploited in polymer industry as a biodegradable alternative to plastics, or in production of biofuels.

Separation of target compound(s) occurs upon propagating extraction fluid 1 through the reaction area 10A containing biomass feedstock. By properly designing the reactor apparatus and/or the reaction chamber (extraction tank) and by establishing certain reaction conditions in the reaction/extraction area (e.g. temperature, pressure, extraction fluid flow rate), a preselected target compound or compounds can be extracted (viz. separated and collected) from feed biomass with high yield (5-30 wt-% dry matter content in extracted sample) and high recovery rate (about 90% of the target compound collectable in one run).

Extraction procedure is conducted using an aqueous fluid as an extractant. The aqueous fluid is typically provided as liquid (i.e. it normally exists in liquid state) and it is converted into a gaseous substance prior to entering the reaction area. In preferred implementations, the extraction fluid is water. Prior to entering the reaction area water is vaporized to form a gaseous phase, namely, aqueous vapour also referred to, in the present disclosure, as steam. Formation of the gas phase is performed by (pre)heating and optional pressurizing the liquid extractant in a first heat-transfer unit 9. The first heat-transfer unit 9 can be configured as a heat-exchanger or as a heater (vaporizer) device disposed upstream the reaction area/the reaction chamber 10A.

To avoid confusion, in present disclosure, the term “phase” (of matter) is used interchangeably with the term “state” (of matter) unless explicitly defined otherwise. The term “steam” is used interchangeably with the term “aqueous vapour” or “water vapour”. For the sake of clarity, both steam and vapour are assumed to designate a gaseous phase (gas phase). In some instances, the term “vapour” is further indicative of a gaseous phase of an aqueous- or non-aqueous solution comprising water or other organic solution as a solvent. The terms “gas phase” or “gaseous phase” are used hereby to designate the state of matter of a substance (e.g. vapour), unless otherwise explicitly indicated. Gas as a distinct element consisting of single gas particles (molecules and atoms, such as O₂, N₂, CO₂, for example) and existing in gaseous state at room temperature is generally designated with the term “gas”.

The present method largely exploits the concept of column chromatography. Thus, separation of the target compounds follows the principles of column chromatography. Biomass material provided in the reaction area/the reaction chamber 10A forms a stationary phase or matrix, while the extraction fluid forms a mobile phase (eluent). Extraction fluid enters the reaction area 10A via an inlet or inlets (not shown) and travels through the biomass material along the length of said reaction area. With an advancement of extraction fluid in gaseous phase through the reaction area, in certain reaction conditions, the target compound (or compounds) separate(s) from the essentially solid biomass material and travel(s), with the extraction fluid as a carrier, towards the end of the reaction area.

Thus, propagation of steam through the reaction area 10A containing biomass material under elevated temperature and pressure causes release of extractable substances contained in plant cells, into the carrier medium (aka the extraction fluid, hereby, steam). Target compounds released/separated from the essentially solid matrix enter the mobile phase (extraction fluid), which extraction fluid carries said target compounds towards the end of the reaction area, followed by recovery of the target compound(s) exiting the reaction area.

Recovery of the target compound(s) can be carried out in a second heat-transfer unit 11, in where the extraction fluid containing the target compounds undergoes cooling and/or condensation, whereby an extract 2 collected upon recovery is essentially liquid. In such an event, the recovery of target compound(s) occurs outside the reaction area 10A.

During the extraction process, the target compounds undergo transition from an essentially insoluble state (forming plant cell walls) into an essentially soluble- or dissolved state. By way of example, typically insoluble hemicelluloses are rendered soluble upon passing steam through the reaction area 10A in a manner described above in reaction conditions involving elevated temperature and pressure.

Target compound(s) transferred, by dissolution or dispersion, into the extraction fluid, move towards the site of recovery 11 with liquid (water) droplets contained in steam and/or liquid released from plant cell vacuoles. Depending on reaction conditions, fluid obtainable at the exit of the reaction area 10A and rich in target compounds may form an essentially gaseous phase, such as an unsaturated vapour or as saturated vapour. Recovery of compounds carried by said fluid(s) is performed in the second heat-transfer unit 11 configured as a cooling appliance 11.

In similar manner, other compounds can be extracted. Some target compounds are not water soluble and can be carried towards the site of recovery in the form of colloidal droplets dispersed in vapour phase. Upon further condensation (11), the extract is rendered liquid. Thus obtained liquid fraction contains the target compound or compounds dissolved- or dispersed in the liquid medium.

In order to produce high-quality products, the reaction conditions in the reaction area/reaction chamber 10A are established as follows. Temperature in the reaction area 10A is adjusted and maintained within a range of about 100-250° C. (degrees Celsius), preferably, 100-220° C., still preferably, 150-210° C. and the pressure is adjusted and maintained within a range of about 0.1 MPa to about 4 MPa (1-40 bar); preferably, about 0.3 MPa to about 3 MPa (3-30 bar). In some instances, further preferred ranges include about 0.6 MPa to about 2.5 MPa (6-25 bar), and, still more preferably, about 1 MPa to about 2 MPa (10-20 bar). In some instances, the extraction conditions may be adjusted to involve temperatures below 100° C., in particular, within a range of about 80-100° C. Temperature can be preserved stable or it can be elevated during the process.

A reaction temperature of about 220° C. generally corresponds to a pressure of 2.3 MPa (23 bar). Higher temperatures, e.g. up to 250° C. or even higher can be further adopted. Saturated steam superheated to about 250° C. can be generated at a pressure of about 4 MPa (40 bar).

In an event saturated steam is used as the extraction fluid, pressure in the reaction area established by virtue of said steam generally follows the following non-limiting examples: about 0.1 MPa (101 kPa or 1 bar) at about 100° C.; about 0,476 MPa (4,8 bar) at about 150° C.; and about 1,555 MPa (15,6 bar) at 200° C. Generally, at a temperature of about 210° C., pressure within a range of about 0.1 MPa-2 MPa (1-20 bar) can be established and maintained.

In some configurations, taken into account such factors as design of the reactor vessel, heat loss and condensation occurring during the reaction, the vapour pressure at least at the beginning of the reactor vessel may be generally lower and constitute about 1-1.5 MPa at about 200° C. From the other hand, steam pressure at the exit depends on packing density, whereupon the exit temperature in a tightly packed reactor may be about 50° C. lower than that at the entrance (with the pressure of about 0.5 MPa and the temperature at about 150° C. or lower in case of potential clogging of the exit port). In dynamic flow (continuous flow) conditions, a dynamic equilibrium can be established for at least pressure and temperature parameters, in which event extraction/fractionation may also be performed in several recovery runs.

Strictly speaking, it is pressure difference(s) between the substance being extracted and the extraction matrix (biomass) that cause extraction/fractionation of the target compounds by enabling or at least promoting movement of the latter through the reaction area matrix. In some instances, preferred steam pressure range thus constitutes about 0.3 MPa to about 3 MPa.

The abovementioned parameters are established in the reaction area 10A by directing the extraction fluid having desired temperature/pressure into the reaction chamber. Medium-(0,45-1.6 MPa) or high-pressure steam (over 2 MPa) generated in the first heat-transfer unit 9 can be directed into the reaction area. Accordingly, the first heat-transfer unit 9 can be configured as low-, medium- and/or high-pressure steam generator or boiler, for example.

By passing medium- or high-pressure steam through the biomass material contained in the reaction area 10A, rapid release of the target compounds from the solid component can be achieved. Residence time of the target compound is defined as a time period that the released/separated target compound spends in the reaction area (hot area). Residence time is short, typically, within a range of about 2-30 min, preferably, within a range of about 5-20 min, still preferably, within a range of about 5-15 min. Due to rapid release of the target components from the stationary phase, the residence time essentially defines a reaction time during which a preselected target compound elutes from the reaction area. Dependent on reaction conditions, extractant flow rate and/or reactor capacity (volume, configuration, position horizontal/vertical), reaction times as short as 2 min, 5 min, 10 min, 15 min and 20 min, and any time period intermediate to those mentioned above, can be attained.

Short residence time is important for obtaining high-quality products, in particular, when the treatment is conducted at high temperatures, such as exceeding 200° C., for example. Keeping residence time short is crucial in extracting essentially intact, long-chain polymeric compounds, such as hemicelluloses. The method described hereby thus allows for extracting essentially intact, long-chain hemicelluloses having about 500-3,000 monosaccharide units. Other polymers and/or molecular clusters can be extracted in similar manner.

Short treatment times further prevent the target compounds, in particular, polymeric molecules, from uncontrolled decomposing (optionally catalytic hydrolysis or autolysis) and/or from undergoing chemical modifications and prohibits formation of toxic and/or inhibitory compounds typically formed upon (partial) degradation of hemicellulose. Additionally, by reducing treatment time to few minutes, biomass feedstock is prevented from thermal degradation (burning).

As mentioned above, the present method follows the concept of column chromatography. Therefore, the method allows for eluting target compounds fraction-wise. Compounds to be separated and recovered referred to as target compounds are indicated on FIG. 1 as C1 and C2. The method thus allows to separate non-identical (see exemplary pentagon- and circle-shapes) compounds C1 and C2 from essentially solid matter forming the stationary phase (aka biomass) and extract each of these compounds separately with high purity. Alternatively, extraction conditions can be adjusted to enable separation and extraction of both compounds C1 and C2 together. The extract 2 obtainable as a product thus contains compounds C1 and/or C2 with high percent recovery (80-95%) and essentially void of any impurities.

The liquid extract 2 obtainable upon recovery and containing the target compound(s) has a dry matter content (solid matter content) within a range of about 5 weight-% to about 30 weight-%.

The reaction parameters, eluent/extractant flow rate, as well as the apparatus-related parameters can be adjusted such that different target compounds are eluted in separate fractions with different retention times. The latter generally means that the non-identical target compounds have different residence times in the reaction zone. By way of example, while a fraction containing the compound C1, such as e.g. intact hemicelluloses, elutes, in certain reaction conditions, in 2-5 min from a time point at which the extraction fluid has been directed into the reaction area 10A; a fraction containing the compound C2, such as e.g. low-molecular weight carbohydrates resulting from decomposition of hemicelluloses (mono-, di- and oligosaccharides and mixtures thereof) elutes at 7-8 min from the start of the reaction. Likewise, more than one- or two target compounds can be separated in one run.

An amount of the extraction fluid needed to obtain the fraction rich in target compound(s) typically constitutes, in the present method, about 0,1-10 volumes, preferably, about 0,5-2 volumes of the biomass feedstock provided in the reaction area, wherein the volume of the aqueous extraction fluid is calculated per liquid state of said fluid. Thus, while extraction fluid, such as water, is rendered gaseous for being propagated through the reaction area (in the form of steam), amount of water needed for recovery of the target compound(s) is calculated as per liquid state thereof.

When water is used as an extractant, pH of the system is generally preserved neutral (pH 7); in an absence of specific adjustments, pH of pressurized water falls below the neutral value and tends to be acidic (pH 3-4). In an event the system is optionally supplied with chemical extractant(s) to assist recovery, pH of the system can vary within a range of 1-14.

The present method is largely based on heat transfer between the mobile phase (extraction fluid, such as steam, propagating through the reactor) and the stationary phase (biomass matrix). In the process, heat is transferred from the extraction fluid to the essentially “cold” matrix at an interface between the essentially gaseous phase (e.g. steam) and the essentially solid phase. Thus, the greater is the area generated by virtue of-/occupied by said interface, the more efficient is energy transfer (heat transfer) between phases. By providing biomass matrices with a predetermined particle size, optionally with a predetermined particle size distribution, the reaction duration and/or residence times may be regulated. In some instances, chopped or finely ground biomass with particle size of about 0.1 cm-10 cm, preferably, about 0.5 cm-5 cm, may be advantageous, as increasing the surface area available for the reaction and expanding the heat transfer interface.

Particle size further effects the packing density. In practice, the reaction area 10A may be configured such as to contain one or more (sub)zone containing particles of different size and/or origin (i.e. from different biomass feedstocks). By virtue of these (sub)zones, eluent/steam pressure can be regulated throughout the reaction area.

Exemplary packing density may vary within a range of about 5-150 g/dm³ or higher.

As described hereinabove, the apparatus/the reaction chamber acts as a heat transfer unit, wherein thermal energy/heat is transferred from the mobile phase to the stationary phase. In an event saturated (aqueous) vapour (viz. steam) is present in the heat transfer/heat exchange, said vapour will, in practice, immediately condense on the cold surfaces of the heat transfer unit (biomass matrix), whose temperature is below the condensation temperature of the steam. Resistance is thus established through a formation of a thin condensate film on the matrix surfaces, through which heat must pass. This resistance factor should be taken into account when designing reaction parameters, such as temperature and pressure, as well as packing density of the matrix. In certain conditions, involving predetermined combination of at least pressure and temperature, a condensed liquid film can be established on the surface of the biomass matrix, which may assist propagation of the separated target compounds through the reaction area (the biomass matrix).

In the method, the feedstock biomass can be further pretreated in a pretreatment stage separate from the extraction stage described hereinabove. Pretreatment of the feedstock can be carried out in the apparatus 10 or in a separate reactor vessel (not shown). In the apparatus 10, pretreatment can be carried out in the reaction area 10A or in a separate pretreatment area (not shown) that can be physically and/or functionally separated from the reaction area 10A.

Pretreatment step conducted prior to the extraction step aims at removal and/or recovery of at least volatile compounds from biomass feedstocks. Volatile compounds include volatile organic compounds (VOCs), e.g. a variety of aromatics, nitrogen oxides (NₓO_{y}) and/or any other vaporizable compounds. Additionally or alternatively, a variety of compounds that prevent and/or hinder the extraction (e.g. silicates) can be removed during the pre-treatment step. An important function of the pre-treatment is to (pre)heat the raw material and to cause its swelling that enables faster and more accurate extraction reactions by the extraction fluid, such as steam. During pretreatment, biomass feed is treated with a pretreatment fluid in reaction conditions involving low- or atmospheric pressure and reaction temperatures generally lower than that used during the extraction. In the method, these conditions include adjusting pretreatment temperature to a range of about 100° C. to about 120° C. and adjusting pretreatment pressure to a range of about 0.05 mPa to about 0.5 MPa (0,5-5 bar). In some instances, pretreatment step can be performed in an absence of excessive pressure/at atmospheric pressure at lower temperatures within a range of about 70-100° C., in particular, 70-90° C.

During pretreatment, biomass material is washed with a gaseous substance used as pretreatment fluid. Gaseous phase can be generated from a suitable solvent, such as water or aqueous solutions of any one of alcohol (e.g. ethanol), acid or alkali, to produce vapour. Alternatively, gaseous substances, such as carbon dioxide, ammonia or sulfur (di)oxide, for example, can be utilized. Pretreatment step can be carried out in an open reactor vessel via steam refining at atmospheric pressure, for example, or in a closed/sealed reactor vessel (gas refining, optionally pressurized).

In another aspect, the invention pertains to a system for separation and recovery of compounds from biomass. FIG. 1, illustrates, at 100, a concept underlying the embodiments of the system and its appliances. The system 100 comprises an apparatus 10 for processing biomass with a reaction chamber (extraction chamber) configured as a tank or a vessel containing biomass feedstock. A reaction area 10A is established within the reaction chamber; therefore, in present disclosure the term “reaction area” generally designates the reaction chamber and vice versa.

Design and geometry of the reaction chamber, in particular, in terms of the ratio between the chamber's height/length and its cross-sectional area (or diameter), are adjusted such, as to enable or assist achieving relatively short reaction-/residence times and fast elution of the target compounds from the reaction chamber. The abovementioned parameters are typically adjusted bearing in mind reaction conditions to be established in the apparatus 10 to attain elution of the target compound(s) in the most efficient manner and in a variety of desired combinations (wherein different desired compounds/different groups of desired compounds are eluted in fractions).

Mentioned ratio between the height/length and the cross-sectional area (or diameter) of the reaction chamber defines its shape coefficient. Depending on reaction temperature and the desired product, the shape coefficient can be adjusted within a range of about 1:1 to about 10:1. Examples include obtaining a reaction chamber with a shape coefficient 2:1, 3:1, 4:1, 5:1 or 6:1. When designing the reactor with particular shape coefficient, care should be taken that residence time (of the target compound) does not increase too much (to avoid thermal degradation) and that the flow of eluent is essentially laminar.

Overall, at least two important issues must be considered upon designing the reaction chamber for the apparatus 10. The chamber should be void of so called blind- or dead corners (e.g. formed at the junction points between flat lids or top covers and/or restricting the fluid flow through the chamber). Presence of dead corners slows down the elution and consequently causes thermal and/or (bio)chemical degradation of the target compounds (eluates), which results in reduced product quality. Additionally, degradation processes occurring in the extraction zone may cause blockages of the matrix and the reactor. Additionally, the shape of the chamber should be preserved essentially tubular. Tubular tank may have same- or varying cross-section throughout the tube.

Extraction chamber of cylindrical shape (a tank having constant cross-sectional area throughout its length) is preferred, since it allows creating uniform extraction fluid, such as steam, distribution throughout the reaction area and to propagate the extraction fluid along the length/height of the chamber with essentially uniform velocity at a leading edge.

The apparatus 10 comprises means for directing extraction fluid into the reaction chamber (indicated by an arrow “in”, FIG. 1) and means to withdraw said extraction fluid rich in the target compound(s) from the reaction chamber (indicated by an arrow “out”). Extraction fluid can be directed into the reaction area via a suitable inlet port, configured as an injection port, for example. Suitable exit port can be arranged at the end of the reaction zone, accordingly. The inlet- and the exit are preferably equipped with appropriate regulators, such as valves. The apparatus 10 can be equipped by several inlet- and/or exit ports optionally provided in the end plates of said apparatus.

The system 100 further comprises a first heat-transfer unit 9, in which the extraction fluid 1, such as water, is (pre)heated and optionally pressurized to form a gaseous phase. The first heat-transfer unit is arranged to vaporize liquid arriving thereto via a source vessel (e.g. water vessel); therefrom resulted (pressurized) steam is directed into the reaction chamber. The first heat-transfer unit 9 can be configured as a heat exchanger, a steam generator or a boiler, as described hereinabove.

Additionally or alternatively, the extraction apparatus 10 may be placed into an external chamber (not shown) acting as a heating jacket, whereby a stream of a heating medium is generated around the apparatus 10 (between an inner wall(s) of the external chamber and an outer wall(s) of the apparatus 10) to enable- or to enhance heat transfer. The heating medium may be the same as the eluent, e.g. steam. Provision of such “double chamber” allows for efficient steam and heat recovery and recycling.

The system 100 further comprises at least one an appliance, in which the target compound(s) C1, C2 exiting the reaction area 10A are recovered. Such an appliance can be provided as a (second) heat-transfer unit 11 arranged downstream the reaction area 10A. In the heat-transfer unit 11, extraction fluid exiting the reaction area 10A is cooled down/condensed to produce an essentially liquid extract 2 rich in the target compound. The heat-transfer unit 11 can be configured as a heat exchanger with a condenser functionality. The product 2 rich in target compound(s) is further collected into a collector appliance 13, configured as a suitable vessel or vessels or as an automated fraction collector, for example.

The first- and the second heat-transfer units 9, 11 can be combined into an integrated heat-transfer/heat exchanger solution (not shown). Whether implemented as separated devices or as an integrated heat exchanger assembly, the system can be configured to (re)use thermal energy released upon cooling the extraction fluid in the second heat-transfer unit 11. Heat released upon cooling can be recycled for use in the heater device 9, for example, and/or exported for external use.

In some instances, the reaction conditions are adjusted such that the extraction fluid may undergo at least partial condensation upon being propagated through the reaction zone. In such as event, fluid obtainable at the exit of the reaction area and rich in product compounds is provided in essentially liquid, flowable phase, which can be collected and used as such or transferred for further condensation/concentration e.g. in the device 11 or other appropriate appliance (not shown).

The system 100 further comprises at least one pump 14 for extraction fluid, disposed upstream the heat-transfer unit 9 and/or upstream the extraction apparatus 10, and a number of control appliances 12, 12A for controlling reaction conditions in the apparatus 10 and associated devices. At least one control device 12 (upstream the apparatus 10) can be configured to regulate reaction conditions in the reaction chamber, in particular, pressure and temperature in the reaction zone 10A. Separate pressure- and temperature controllers can be provided. A flowmeter to measure and/or regulate flow rate of fluid entering the reaction chamber can be integrated into the device(s) 12 or provided separately. A heat recovery system (not shown) can be further provided to enable heat transfer/heat exchange between the first- and second heat-transfer units 9, 11 and/or to recover thermal energy produced in the heat-transfer units 9, 11 for external use.

The pump 14 and/or the control appliance 12 can be configured to direct the extraction fluid into the reaction area 10A continuously or in pulses. Pulse duration is adjustable reaction-wise.

The apparatus 10 can be configured as a static (batch) reactor, a dynamic (continuous-flow) reactor or as a combination thereof (e.g. a semicontinuous-flow system). An exemplary system with a vertical batch reactor 10 is shown on FIG. 1. Extraction fluid is directed through the reaction area 10A from top to bottom. Vertical reactors can be equipped with reaction chambers provided in essentially cylindrical shape (having same cross-section throughout the entire length of the chamber), cone- or funnel-shaped or having more complex design.

Alternatively, the apparatus 10 can be implemented as a continuous, plug flow reactor (not shown). In such an event the reactor is positioned essentially horizontally with or without inclination. Feasible configurations include screw- or piston operated, continuous flow reactor apparatuses. In an exemplary screw reactor based system, a rotatable screw is disposed in the reaction chamber/reaction area 10A.

In screw-type continuous-flow systems, optimal reaction times are attained by adjusting (rotational) screw speed and/or screw parameters, such as thread angle (more/less steep), helix angle and/or pitch, as well as by regulating pressure- and/or amount of extraction fluid, such as steam, propagated through the reactor. It is preferred, that extraction fluid is propagated, in the continuous-flow reactor apparatuses, in a direction opposite to the direction of rotation of the screw (or direction of piston movement).

Continuous-flow reactor systems may be further equipped with a screw-press for excessive fluid removal. Screw-press may be provided in the reaction area 10A or in a separate process stage arranged downstream the reaction area 10A. Removal of excessive fluid can occur under pressure, or the stage may be depressurized (by providing a screw with less steep thread angle or via a conventional steam explosion procedure, for example). Depressurizing of the apparatus 10 is performed only after the desired target compounds have been recovered as the extract 2 in the site of recovery 11, for example.

The method disclosed hereinabove can be advantageously applied for separation and recovery of essentially intact, long-chain hemicellulose compounds from lignocellulosic biomass. By essentially intact, long-chain hemicellulose compounds we refer hereby to hemicelluloses comprising about 500-3,000 monosaccharide units. In some instances, the method enables separation and recovery of hemicelluloses comprising about 1,500-2,000 monosaccharide units. That the recovered hemicellulose compounds are long-chain, high molecular weight compounds, has been determined by light-scattering methods.

Plant hemicellulose is a mixture of polysaccharides generally defined, based on their structural features, as xylans (arabinoxylans, glucoronoxylans), mannans (glucomannans, galactomannans), xyloglucans, beta-glucans and galactans. Composition of a hemicellulose-containing extract may thus vary depending on a feedstock. For example, while hardwoods and various grass-derived biomasses are rich in xylans, softwoods predominantly contain mannans. The method presented hereby is versatile in a sense that it allows extraction of long-chain hemicellulose polysaccharides from nearly any type of biomass feedstock, in particular, lignocellulosic biomass feedstocks.

In the method, a lignocellulosic biomass feedstock is received into the reaction chamber of the apparatus 10 for processing biomass, whereby a reaction area 10A containing said biomass feedstock is formed. Water 1 is guided into the first heat-transfer unit 9 by means of the pump 14, in which heat-transfer unit 9 water is vaporized under elevated temperature and pressure to form a gaseous phase, hereby, steam. Steam as an extraction fluid is propagated through the reaction area containing biomass material, in predetermined reaction conditions that cause partitioning of the hemicellulose compounds from the essentially solid feedstock matter. Reaction conditions (temperature, pressure, reaction duration and water flow rate) are adjusted such that an amount of lignin separating from biomass matrix material remains negligible, whereby an exceptionally pure hemicellulose product can be obtained in unaltered, essentially intact form. The product is collected, as an essentially liquid extract 2, in the recovery area 11. Liquid extract 2 is preferably produced in the (second) heat-transfer unit 11, in where hemicellulose-rich steam is cooled down/condensed to produce a liquid phase. Recovery rate of pure long-chain hemicellulose product constitutes 80-95%.

Reaction conditions comprise adjusting temperature in the reaction area 10A to a range between about 160-220 degrees Celsius and adjusting pressure in the reaction area to a range between about 0,6-2.5 MPa.

The processes underlying the extraction of hemicelluloses can be summarized as follows. In conditions of elevated temperature and pressure, hemicellulose compounds contained in plant cells (lignocellulosic biomass feedstocks) are rendered soluble (“liquefied”) and are transferred into the mobile phase. Water molecules contained in the mobile phase assist propagation of the target hemicelluloses through the reaction zone, whereby hemicelluloses are carried towards the exit of the reaction area and the site of recovery in the form of gel-like droplets dispersed in vapour phase.

In the steam extraction experiments, the process temperature has proved an important regulating factor.

In a number of experimental trials, more than 90% of high-quality product, hereby, long-chain hemicelluloses was recovered by elution with steam volume corresponding to a range between approximately ⅗ volumes of the extraction tank and a full volume of the extraction tank, with solid content in the hemicellulose-rich extract being about 5-10 wt-%. Reaction duration was approximately 5-10 min. The extraction fluid flow rate of 300 ml/min has proved the most beneficial (for a 3 L reaction chamber). Thus, in 4-5 min from the beginning of extraction, more than 90% of a total amount of carbohydrates could be separated and recovered. In about 7-8 min reaction time, solid content of extracted carbohydrates exceeded 20 wt-%. Analysis of the solid biomass matrix after the elution has demonstrated that in some instances less than 1 wt-% of hemicellulose has remained in said matrix.

Trials were conducted in the reactor tanks having capacity 0,05 L, 1 L and 3 L. Results are summarized in Tables 1 and 2. The Brix value (%) denotes a measure of the sugar content in a solution.

Trial 1 (Table 1A, 1B). Steam extraction to produce long-chain hemicellulose compounds: sawdust 40 g, dry solid (ds) content 50%; elution flow rate 5 ml/min; 200° C.; reactor capacity 0,05 L.

TABLE 1A
Continuous steam extraction.

| Fraction | 0 | 1 | 2 | 3 | 4 |
|---|---|---|---|---|---|
| Product concentration, | 15.50 | 14.70 | 4.47 | 2.01 | 1.38 |
| solid content (wt-%) | | | | | |
| pH | n/a | 3.54 | 3.18 | 3.18 | 3.22 |
| Elution volume (ml) | 2 | 30 | 20 | 20 | 50 |
| Brix (%) | n/a | 14 | 4 | 2 | 1 |

TABLE 1B
Steam extraction with extraction fluid directed
into the reaction chamber in pulses.

| Fraction | 0 | 1 | 2 | 3 | 4 |
|---|---|---|---|---|---|
| Product concentration, | 19.98 | 13.80 | 3.88 | 0.98 | 0.95 |
| solid content (wt-%) | | | | | |
| pH | 3.58 | 3.38 | 3.23 | 3.4 | 3.49 |
| Elution volume (ml) | 4.2 | 30 | 20 | 25 | 20 |
| Brix (%) | >20 | 13.50 | 3.50 | 1 | 0.50 |

Trial 2 (Tables 2A-2D). Steam extraction to produce long-chain hemicellulose compounds: sawdust d.s. 42%; pretreatment fluid flow rate 500 ml/min. Reaction parameters: 200° C.; elution flow rate 100-500 ml/min. The results of Trial 2 indicate that carbohydrates (sugars) are extracted from fresh biomass sample in few minutes from directing steam into the extraction chamber.

TABLE 2A
Sample: fresh sawdust 1531 g; reactor
capacity 3 L. Reaction duration 10 min.

| Sample, 3 L; | Product concentration, | Elution | Elution flow rate |
|---|---|---|---|
| 10 min | solid content (wt-%) | volume (L) | (ml/min) |
| 1 | 1.00 | 1 | 500 |
| 2 | 4.00 | 1 | 500 |
| 3 | 5.00 | 1 | 500 |
| 4 | 4.00 | 1 | 500 |
| 5 | 2.00 | 1 | 500 |
| 6 | 2.00 | 1 | 500 |
| 7 | 1.00 | 1 | 500 |
| 8 | 0.80 | 1 | 500 |
| 9 | 0.50 | 1 | 500 |
| 10 | 0 | 1 | 500 |

TABLE 2B
Sample: fresh sawdust 1587 g; reactor
capacity 3 L. Reaction duration 10 min.

| Sample, 3 L; | Product concentration, | Elution | Elution flow rate |
|---|---|---|---|
| 10 min | solid content (wt-%) | volume (L) | (ml/min) |
| 1 | 1.00 | 1 | 300 |
| 2 | 5.00 | 0.5 | 300 |
| 3 | 6.00 | 0.75 | 300 |
| 4 | 5.50 | 1 | 300 |
| 5 | 4.00 | 1 | 300 |
| 6 | 2.00 | 1 | 300 |
| 7 | 0.20 | 1 | 300 |
| 8 | 0 | 1 | 300 |
| 9 | 0 | 1 | 300 |
| 10 | 0 | 1 | 300 |

TABLE 2C
Sample: fresh sawdust 493 g; reactor capacity
1 L. Reaction duration 6 min.

| Sample, IL; | Product concentration, | Elution | Elution flow rate |
|---|---|---|---|
| 6 min | solid content (wt-%) | volume (L) | (ml/min) |
| 1 | 7.00 | 0.5 | 300 |
| 2 | 4.00 | 0.5 | 300 |
| 3 | 1.00 | 0.5 | 300 |
| 4 | 0 | 0.5 | 300 |
| 5 | 0 | 0.5 | 300 |
| 6 | 0 | 0.5 | 300 |

TABLE 2D
Steam extraction: fresh sawdust 452 g; reactor
capacity 1 L. Reaction duration 6 min.

| Sample, 1 L; | Product concentration, | Elution | |
|---|---|---|---|
| 6 min | solid content (wt-%) | volume (L) | Elution flow rate |
| 1 | 6.00 | 0.5 | 100 |
| 2 | 5.50 | 0.5 | 100 |
| 3 | 2.00 | 0.5 | 100 |
| 4 | 1.50 | 0.5 | 100 |
| 5 | 0.20 | 0.5 | 100 |
| 6 | 0 | 0.5 | 100 |

Experimental trials were conducted as follows. An exemplary 3 L tank was preheated with steam as a pretreatment fluid directed into the extraction tank at 200° C. and flow rate of 500 ml/min. After pretreatment, steam as extraction fluid was directed into the tank at a flow rate of 500 ml/min (1^{st} experiment; Table 2A) and 300 ml/min (2^{nd} experiment; Table 2B). In present disclosure, flow rate is calculated as per liquid state of said extraction fluid. The extraction fluid flow rate in present experiments thus corresponds to a feed water pumping rate. From Table 2B it can be observed that in a 3 L tank at a flow rate of 300 ml/min, about ⅘ of total amount of hemicelluloses can be recovered in about 10 min time. Residence time of hemicelluloses in the extraction tank is about 20 min from the beginning of the extraction. High-quality solid matter content in the extract thus obtained was about 5% and approached a standard value obtainable in industrial (up)scalable processes. Hemicellulose species demonstrated sharp elution area essentially at the beginning of the extraction process and short residence time, accordingly. Overall, extraction of carbohydrates was completed when about 6 L (double extraction tank capacity) of extraction fluid calculated per liquid state thereof (viz. water) has traveled through the reaction area containing sample biomass.

In experiments involving the flow rate of 500 ml/min (Table 2A), the elution area was clearly broader and similar yield was achieved with about 5 L elution volume instead of about 3,3 L elution volume (Tables 2A, 2B).

In both experiments, the extracted product was essentially intact, long-chain hemicellulose species. Determination of molecular weight of the extracted compounds has been performed by light-scattering methods.

Experiments were repeated in a 1 L extraction tank (Tables 2C, 2D). In similar manner as described above, the tank was preheated with steam as pretreatment fluid directed into the extraction tank at 200° C. and feed water pumping rate 500 ml/min. After pretreatment, steam as extraction fluid was directed into the tank at flow rates of 300 ml/min (1^{st} experiment; Table 2C) and 100 ml/min (2^{nd} experiment; Table 2D). These experiments aimed at keeping the residence times short by means of reducing the size of the extraction tank. Fractions containing so called condensate water were not collected during extraction in 1 L tank trials, on the contrary to 3 L tank trials, in where condensate water flowed down the reaction zone by gravity or it was admixed with the extract.

The extraction fluid flow rate of 300 min/ml has proved the most beneficial also in 1 L extraction tanks. The flow rate of 100 ml/min gave a good carbohydrate elution profile in the beginning of extraction; however, due to a slow speed combined with high temperature (200° C.) the sample was damaged by thermal degradation (burning). Additionally, the abovementioned flow rate gave a broad elution area.

Residence time (time that separated hemicelluloses spend in the extraction (hot) area) also influences the quality of hemicellulose species. By way of example, the above described 1 L extraction tank was implemented as a cylinder with height/length 160 mm and the diameter 88 mm (height: diameter coefficient=160:88=1,8). This configuration worked well if the extraction fluid flow rate was high (300 ml/min); however, with slower flow rates (100 ml/min) the sample started to “burn” (Tables 2C, 2D). On the contrary to residence times, the geometry of the extraction vessel was essential but not critical for the product yield and/or quality. In the experiments it has been established that the method disclosed hereby and utilizing steam as extraction fluid feasibly operates over a rather wide geometrical range. For continuous-flow processes, the geometry of the extraction vessel appears more critical than for batch processes. In any event, the geometry of the extraction vessel should be designed bearing in mind the desired/required products. Although the product characteristics, such as quality (e.g. degree of degradation), yield, concentration and recovery rate, may be influenced, to some extent by reaction conditions, an improperly designed extraction chamber may eradicate the benefits brought forth by the steam extraction method.

The results presented above clearly demonstrate that steam treatment is an efficient tool for fractionating biomass components. The extraction process may be completed in about 10 minutes or even faster, whether production of a high-quality product is desired. Chromatographic steam elution enables separation and isolation of a most pure part of hemicellulose species. Thus, the method allows for producing an extract having solid content of about 5-6 wt-% with good shelf-life. The steam extraction described herein above saves water, energy and time compared to conventional hot water extraction methods.

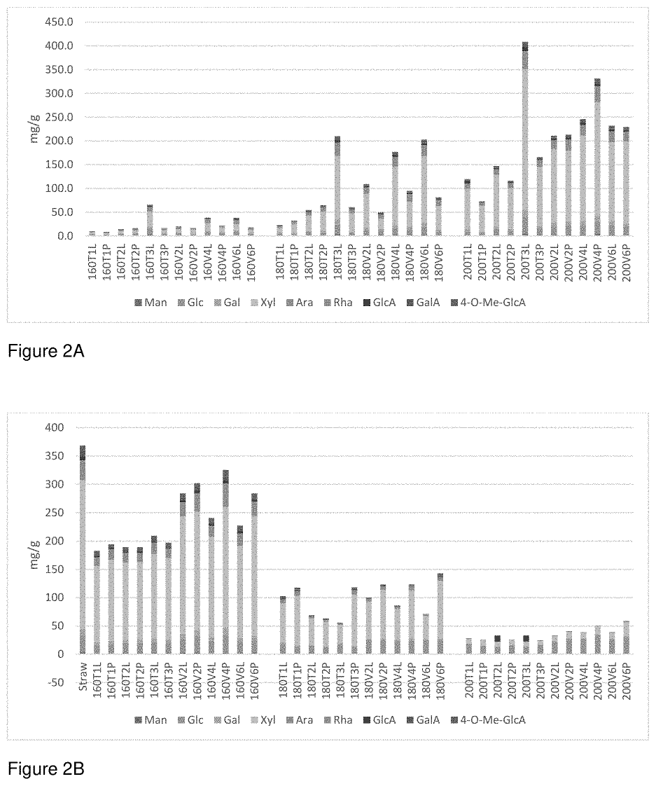

A number of additional experimental trials has been carried out aiming at estimating the effect(s) of reaction- and setup-related parameters on separation of target hemicellulose compounds from biomass by steam extraction. Untreated wheat straw was used as a reference material (marked as “Straw”, FIG. 2B). Reaction duration was 15 min, and the samples were collected at three-minute intervals, thus yielding five (5) samples from each extraction. The trials involved different temperature ranges, namely, the reaction temperatures were selected separately within a range of about 160-165° C., within a range of about 180-185° C. and within a range of about 195-200° C.

Same extraction series (three different temperatures, namely 160° C., 180° C. and 200° C.; reaction duration 15 min; five extraction samples) were conducted for (chopped) straw biomass fractions having straw length of: 1) 0.2 to 0.5 cm (marked with a Latin character “L”, see FIGS. 2A, 2B) and 2) 1,5 to 2 cm (“P”). Packing densities of 200 g/dm³ (“V”) and 300 g/dm³ (“T”) were utilized.

The most optimal, in terms of energy consumption, packing densities include values within a range of about 100-350 g/dm³.

The experiments were performed in a laboratory scale extraction tank with a 6 ml extraction chamber. The tank had essentially cylindrical shape. Biomass material was pre-treated by propagating (water) steam through the reaction chamber with simultaneous heating to achieve the packing densities indicated above. Extraction ratios for the chamber with a higher packing density (300 g/dm³) were 1:1, 2:1 and 3:1; and the same for the chamber with a lower packing density (200 g/dm³) were 2:1, 4:1 and 6:1. Extraction ratio is defined as a total amount of extraction fluid calculated per its liquid state and used during the extraction in relation to the volume of the reaction chamber. In present example, the extraction fluid was (water) steam. An eluted product (the hemicellulose-rich liquid extract), as well as a solid residual fraction (a so-called non-extracted biomass) were analyzed to determine the amount of carbohydrate (sugar) compounds therein. The results are summarized in FIGS. 2A and 2B, accordingly.

FIG. 2A is a graph illustrative of a total amount of hemicellulose sugar compounds obtained during steam extraction series as described above and measured in liquid hemicellulose-rich extract(s). The graph shows the amount of extracted hemicellulose product (mg) per gram of (steam-treated) straw biomass. FIG. 2B is a graph illustrative of the total amount of hemicellulose sugar compounds contained in solid residual biomass after the extraction series (mg/g).

Abbreviations utilized for sample identification are generally explained above. By way of example, a leftmost sample marked as “160T1 L” indicates that the extraction was performed at 160° C. in a reaction chamber densely packed (300 g/dm³) with shorter straws (0,2 to 0.5 cm) at the extraction ratio of 1:1; whereas a rightmost sample marked as “200V6P” refers to the extraction process performed at 200° C. in a reaction chamber loosely packed (200 g/dm³) with longer straws (1,5 to 2 cm) at the extraction ratio of 6:1.

Hemicellulose sugar compounds measured in the extracted fractions included mannose (Man), galactose (Gal), xylose (Xyl), arabinose (Ara), rhamnose (Rha), Glucuronic acid (GlcA), Galacturonic acid (GalA), and 4-O-Methylglucuronic acid (4-O-Me-GlcA).

The results of FIGS. 2A and 2B indicate that the extraction temperature of 200° C. yields a greater amount of eluted hemicellulose compounds. FIG. 2B shows, for example, that the amount of hemicellulose sugars in the solid phase (steam-treated straw) decreases with increased extraction temperature, while the situation is the opposite in the liquid product (FIG. 2A).

With reference back to FIG. 2B, at 160° C., a higher extraction rate was observed in densely packed (T; 300 g/dm³) columns. At 180° C., higher extraction rates were observed in densely packed columns in conditions involving the extraction ratios of 2:1 (long-straw matrix; see sample 180T2P) and 3:1 (short-straw matrix; see sample 180T3 L). For the loosely packed columns (V; 200 g/dm³), higher extraction rates were observed at medium temperatures (180° C.) with the short-straw matrices as compared to the long-straw matrices. At 200° C., a slightly greater amount of hemicellulose compounds was again observed in densely packed columns (T).

However, the results of FIG. 2A indicate that when measured directly from the samples containing hemicellulose-rich (liquid) extracts, the concentration of hemicellulose compounds appears greater in the samples collected from the reaction chambers with less dense packing. The extracts obtained from the short-straw matrices contained, in average, more hemicellulose sugars than that obtained from the long-straw matrices.

The results of FIGS. 2A and 2B clearly demonstrate that the yields of hemicellulose compounds can be efficiently regulated by adjusting the reaction- and setup-related parameters.

To determine sugar content in untreated biomass as compared to steam-treated biomass, the trials were upscaled to a 3 L extraction tank with the following extraction conditions: 200° C., packing density 200 g/dm³ and the extraction ratio 2:1. Values marked with a “less-than” sign (“<”) refer to concentrations below a determination threshold. The results are summarized in Table 3.

TABLE 3
Carbohydrate content measured in an untreated solid
fiber matrix (straw) and in the fiber matrix treated
with steam at 200° C. in a 3 L extraction tank.

| | | | | | | Total |
|---|---|---|---|---|---|---|
| | Ara | Gal | Glu | Xyl | Man | carbohydrate |
| | %/carbohydrate | | | | | mg/100 mg |
| Untreated straw | 1.13 | 0.85 | 76.3 | 21.7 | <0.5 | 72.8 |
| Steam-treated straw | <0.3 | 0.56 | 93.6 | 5.89 | <0.5 | 73.4 |

In the untreated straw matrix, the total amount of carbohydrates was 72,8%, which essentially corresponds to the total amount of carbohydrates in the steam-treated matrix (73,4%). However, the portion of glucose (Glu) with regard to a total amount of carbohydrates in the steam-treated matrix has increased from 76,3% to 93,6%, while the portion of xylose (Xyl) has been reduced from 21,7% to about 5,9%. This result clearly indicates that elution of hemicellulose compounds takes place (reduction of xylose sugars), while the remaining carbohydrates are mainly cellulose-derived glucose sugar units.

It should be clear to a person skilled in the art that the inventive concept is intended to cover various modifications of basic embodiments disclosed hereby. The examples presented hereinabove are understood to be illustrative of various embodiments of the present invention and should not be understood restrictively with respect to the scope of appended claims.

1. A method for separation and recovery of compounds from biomass, the method comprises:
providing a biomass feedstock in an apparatus for processing biomass, thus forming a reaction area containing said biomass feedstock;
propagating an extraction fluid in gaseous phase through the reaction area containing said biomass feedstock, in predetermined reaction conditions, whereby a target compound separates from essentially solid feedstock matter; and
recovering thus separated target compound exiting the reaction area;
wherein, with an advancement through the biomass material along the length of said reaction area, the extraction fluid carries the separated target compound towards the end of the reaction area such, that an extract collected upon recovery is essentially liquid, and wherein the target compounds are extracted fraction-wise such, that the target compounds forming different fractions are eluted with different retention times.

2. The method of claim 1, further comprising, prior to directing the extraction fluid into the reaction area, heating said extraction fluid in a first heat-transfer unit, whereupon the extraction fluid is vaporized to form a gaseous phase.

3. The method of claim 1, wherein, prior to formation of the gaseous phase, the extraction fluid is an aqueous solution.

4. The method of claim 1, wherein the biomass feedstock is cellulose-containing biomass.

5. The method of claim 1, wherein the extraction fluid is directed into the reaction area continuously or in pulses.

6. The method of claim 1, wherein the reaction conditions include adjusting temperature within the reaction area to a range of 100-220 degrees Celsius.

7. The method of claim 1, wherein the reaction conditions include adjusting pressure within the reaction area to a range of about 0.3 MPa to about 3 MPa.

8. The method of claim 1, wherein flow of the extraction fluid through the reaction area is adjusted such that a residence time the separated target compound spends in the reaction area is within a range of about 2 min to about 30 min.

9. The method of claim 1, wherein recovery of the target compound exiting the reaction area includes cooling the extraction fluid carrying the target compound in a second heat-transfer unit arranged downstream the reaction area to produce an essentially liquid extract rich in said target compound.

10. The method of claim 1, wherein an amount of the extraction fluid for recovery of the target compound constitutes about 0.1-10 volumes of the biomass feedstock provided in said reaction area, the volume of the extraction fluid calculated per liquid state thereof.

11. The method of claim 1, wherein a dry matter content in the essentially liquid extract collected upon recovery and containing the target compound is within a range of about 5 weight-% to about 30 weight-%.

12. The method of claim 1, wherein, prior to extraction with the extraction fluid, the biomass feedstock is pretreated with a pretreatment fluid to recover at least the volatile compounds, wherein pretreatment is conducted at a temperature within a range of 70-120 degrees Celsius and pressure within a range of about 0.05 mPa to about 0.5 MPa.

13. The method of claim 12, wherein the pretreatment fluid is a gaseous substance.

14. The method of claim 1, wherein the reaction area is formed in the apparatus for processing biomass configured as a batch reactor, a continuous-flow reactor or as a combination thereof.

15. The method of claim 1, wherein the target compound is selected from a group consisting of cellulose, hemicelluloses, lignin, sugars, proteins and low molecular weight extractive compounds.

16. The method of claim 1, wherein the target compound is essentially intact, long-chain hemicellulose.

17. A system for separation and recovery of compounds from biomass, the system comprises:
an apparatus for processing biomass with a reaction chamber containing said biomass feedstock and forming a reaction area;
means for directing an extraction fluid in a gaseous phase into the reaction chamber, whereby said extraction fluid propagates through the reaction area and separates a target compound from the essentially solid feedstock matter, and, with an advancement through the biomass material, said aqueous extraction fluid carries thus separated target compound towards the end of the reaction area;
a first heat-transfer unit, in which the extraction fluid is heated to form a gaseous phase prior to entering the reaction chamber;
a second heat-transfer unit, in which the extraction fluid exiting the reaction area is condensed to produce an essentially liquid extract rich in the target compound; and
at least one control device to regulate reaction conditions in the reaction chamber, wherein said system is configured for fraction-wise extraction of the target compounds such, that the target compounds forming different fractions are eluted with different retention times.

18. A method for separation and recovery of essentially intact hemicellulose compounds from lignocellulosic biomass, the method comprises:
providing a lignocellulosic biomass feedstock in an apparatus for processing biomass, thus forming a reaction area containing said biomass feedstock;
propagating steam as an extraction fluid through the reaction area containing said biomass feedstock, in predetermined reaction conditions, whereby hemicellulose compounds separate from the essentially solid feedstock matter; and
recovering thus separated intact hemicellulose compounds exiting the reaction area, wherein, with an advancement through the biomass material along the length of said reaction area, the aqueous extraction fluid carries thus separated hemicellulose compounds towards the end of the reaction area such, that an extract collected upon recovery is essentially liquid; and
wherein said hemicellulose compounds are extracted fraction-wise such, that the intact hemicellulose compounds and the products of degradation thereof forming different fractions are eluted with different retention times.

19. The method of claim 18, comprising adjusting temperature in the reaction area to a range between about 160-220 degrees Celsius and adjusting pressure in the reaction area to a range between about 0.6-2.5 MPa, to obtain a fraction containing 80-95% of the total amount of said intact hemicellulose compounds.

20. The method of claim 2, wherein, prior to formation of the gaseous phase, the extraction fluid is an aqueous solution.
